(19) United States
(12) Patent Application Publication
(10) Pub. No.: US 2012/0294374 A1
(43) Pub. Date: Nov. 22, 2012

(54) CONDITIONAL REPLENISHMENT FOR THREE-DIMENSIONAL IMAGES WITH BLOCK-BASED SPATIAL THRESHOLDING

(76) Inventor: Amir SAID, Cupertino, CA (US)

(21) Appl. No.: 13/109,814

(22) Filed: May 17, 2011

(51) Int. Cl. H04N 7/26

(52) U.S. Cl. 375/240.25; 375/E07.027

(57) ABSTRACT

A decoding architecture for decoding a multi-dimensional image for display in a light field display is provided. The multi-dimensional image is compressed in a plurality of blocks, with each block storing compressed light field data and a displacement range. A spatial thresholding module compares the displacement range in each block of the image to a difference between a current decoding position and a previous decoding position. A decoder module decodes a block according to a result oldie comparison.

### BACKGROUND

Autostereoscopic displays have emerged to provide viewers a visual reproduction of three-dimensional (“3D”) real-world scenes without the need for specialized viewing glasses. One example of an effective yet simple display system to provide glasses free, continuous 3D at a low cost consists of a camera system that tracks the position (x, y, and z) of a user's eyes and a 2D stereoscopic display that has multiple views updated in real time according to the position of the display relative to the user's eyes. This approach is currently feasible in real-time using Computer Graphics and synthetic content, since Graphics Processing Units (“GPUs”) are able to render the desired views fast enough. However, real-time rendering is not feasible for light fields derived from cameras and natural scenes, or high-quality ray-traced graphics, as they may require anywhere from seconds to hours for rendering a single view.

The most currently adopted solution is to render the views off-line and store a very large number of views for many values of eye positions. The display system then reads and displays one of the views that best matches the eyes' position when tracking the user's eyes. Since eye position can change very quickly, it may be infeasible to achieve real-time performance with high resolution views. This problem may be alleviated by loading the multiple views into a fast memory, but since the number of views can be quite large, not all of the views may fit in the available memory. An alternative is to store the multiple views in compressed format, load them in compressed form to the fast memory and decompress them only when needed. While this may solve the memory problem, the computational time to decompress each view may be significant, thus making it difficult to render 3D light fields in real-time.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example of an architecture for decoding a compressed 3D image;

FIG. 2 is an example block diagram of the decoding architecture of FIG. 1 in more detail;

FIG. 3 is an example flowchart for decoding a compressed 3D image; and

FIG. 4 is a block diagram of an example of a computing system for decoding a compressed 3D image according to the present disclosure.

### DETAILED DESCRIPTION

A decoding architecture is disclosed to efficiently decode a compressed 3D image storing light field data for a light field display. A light field display, as generally described herein, is a display capable of receiving and displaying light field data. Light field data, which represents the amount of light traveling in every direction through every point in space, may include both light field information such as view depth as well as visual data corresponding to the light field (e.g., RGB, YCrCb data, and so on). Each element in the display screen, referred to herein as a “projexel”, generates light beams with different colors and intensities for different viewing directions. The display screen may be a tiled array/matrix of projexels, with each tile representing a collection of projexels. Examples of light field displays may include holographic displays, parallax displays, volumetric displays, lenticular displays, or any other type of display capable of reproducing a light field, such as displays integrated with special purpose lenses and optical components.

In various embodiments, the light field data may include compressed light field data acquired by one or multiple cameras in a camera array and encoded by one or multiple encoders, such as MPEG encoders, H.26* encoders, multiview encoders, hierarchical encoders, or any other type of encoder for compressing visual information. For example, the light field data may include compressed 3D data representing compressed visual information for the x, y, and z coordinates for a given image or video frame, which is typically divided into blocks (e.g., 8×8, 16×16, 32×32) and compressed in a block-based manner. As described herein below, the light field data also includes a range of displacement (Δx, Δy, Δz) for each image block. The range of displacement, as generally referred to herein, represents a spatial range that can occur before the change in this image block relative to a previous block is large enough, thus warranting decoding of the block. This range of displacement can be coded with a few bits, so it doesn't degrade compression efficiency much and is very simple to process. The task of computing the range of displacement is done only by the encoder compressing the light field data, which does not need to be in real-time.

The acquired, compressed light field data is delivered directly to the decoding architecture, which as described in more detail herein below for various embodiments, includes at least one module for decoding the compressed data and presenting it to the display screen for display. The module(s) keeps track, for each image block, of the displacement range (Δx, Δy, Δz) and the previous and current decoding positions (i.e., the x, y, and z coordinates used for decoding the previous and current image blocks, respectively). If the magnitude of any of the coordinate differences (i.e., the differences between the image values for the previous and current decoding positions) is larger than the displacement range (Δx, Δy, Δz), then the image block is decoded by the decoder module and “replenished” with decompressed data. Otherwise, the image block is maintained as is, thereby reducing decoding time and computational complexity without at the expense of visual quality.

It is appreciated that embodiments of the decoding architecture described herein below may include additional modules. Some of the modules may be removed and/or modified without departing from a scope of the decoding architecture. It is also appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

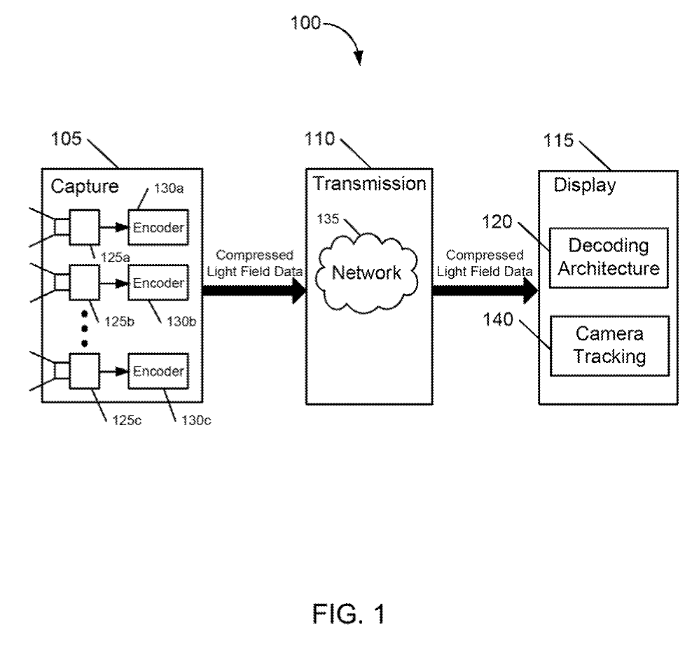

Referring now to FIG. 1, an example of an architecture on which the embodiments may be implemented for decoding a compressed 3D image is illustrated. Architecture 100 is composed of three main portions: a capture portion 105, a transmission portion 110, and a display portion 115. Display portion 115 includes the decoding architecture 120 for processing and decoding a compressed 3D image storing light field data for display.

A 3D light field may be captured by one or more cameras in a camera array within capture portion 105, such as, for example, cameras 125a-c. Each camera may capture images and video in real-time representing multiple viewpoints to create a dynamic light field. The dynamic light field may represent multiple views of a three-dimensional image captured by the cameras 125a-c. The cameras 125a-c may be aligned and placed in a given configuration (e.g., spaced apart in a linear configuration) or arranged arbitrarily. It is appreciated that the cameras 125a-c may be integrated into a single camera device or include multiple camera devices. It is also appreciated that cameras 125a-c may include any type of camera capable of acquiring digital images and video, such as, for example, CCD cameras, CMOS cameras, and the like.

The data captured by cameras 125a-c may be typically encoded/compressed by one or more encoders, such as, for example, encoders 130a-c. Each encoder 130a-c may generate encoded/compressed data according to one or more coding approaches, such as those outlined in the various MPEG, H.26*, and other coders. In various embodiments, each encoder 130a-c compresses the light field data in a block-based manner, by first dividing each image (or view) into blocks (e.g., 8×8, 16×16, or 32×32 blocks) and compressing each block. A range of displacement (Δx, Δy, Δz) is then determined for each image block and encoded in the block together with the compressed image data for the (x, y, z) coordinates in the block. The range of displacement, as generally referred to herein, represents the spatial range that can occur before the change in this image block relative to a previous block is large enough, thus warranting decoding of the block. Those of skill in the art would appreciate that the encoders 130a-c may be separate from or integrated with the cameras 125a-c. Those of skill in the art would also appreciate that the range of displacement is a block-based spatial threshold.

The compressed data generated by the encoders 130a-c, i.e., the compressed (x, y, z) values for each image block together with the range of displacement (Δx, Δy, Δz) encoded in each block, is transmitted to the display portion 115 via a network 135, which may be the Internet, a broadband network, or any other network used for sending data between a source and a destination. Alternatively, in one embodiment, the capture portion 105 and the display portion 115 may be integrated (e.g., in a one or more devices) such that the network 135 may not be needed for transmitting the compressed data from the capture portion 105 to the display portion 115. Instead, network modules may be added to the integrated device(s) for sending data between the capture portion 105 and the display portion 115, such as, for example, network modules in the cameras 125a-c or in the encoders 130a-c.

The display portion 115 includes the decoding architecture 120 for decoding and processing the compressed data sent by the capture portion 105 in order to extract and display the 3D light field captured by the capture portion 105. The decoding architecture 120, described in more detail herein below, is designed to exploit the large amounts of redundancy present in natural light fields, so that the amount of information processed is greatly reduced by decoding only those image blocks that differ significantly from the previous decoded blocks, as determined by the range of displacement encoded in each block. The display portion 115 may also include a camera system 140 that tracks the position (x, y, and z) of a user's eyes and a 2D stereoscopic display for displaying the decoded image.

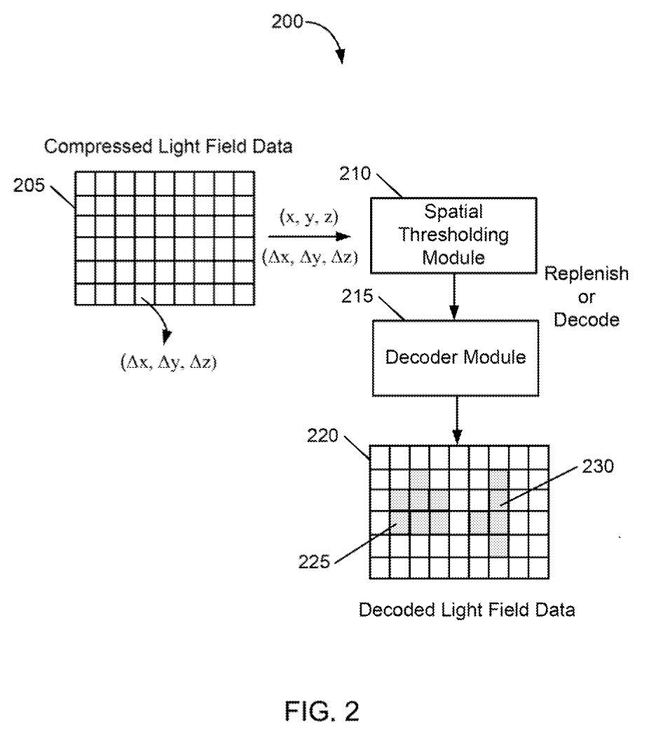

Attention is now directed to FIG. 2, which illustrates an example block diagram of the decoding architecture of FIG. 1 in more detail. Decoding architecture 200 is an architecture for decoding compressed light field data acquired by the capture portion 105. The light field data may include 3D data representing visual information for the (x, y, and z) coordinates for a given image or video frame, such as, an image or frame representing a view of a 3D scene. The image or frame is typically divided into blocks (e.g., 8×8, 16×16, 32×32) and compressed in a block-based manner, such as, for example, the compressed light field data 205.

Each block in the compressed light field data 205 contains compressed visual information for the (x, y, and z) coordinates in the block as well as a range of displacement (Δx, Δy, Δz) for each image block. The range of displacement, as described above, represents a spatial range that can occur before the change in this image block relative to a previous block is large enough, thus warranting decoding of the block. This range of displacement can be coded with a few bits, so it doesn't degrade compression efficiency much and is very simple to process. The task of computing the range of displacement is done only by the encoder compressing the light field data, e.g., encoders 130a-c, which does not need to be in real-time.

The compressed light field data 205 is decoded in a block-by-block manner by the Spatial Thresholding Module 210 and the Decoder Module 215. The Spatial Thresholding Module 210 keeps track, for each image block, of the displacement range (Δx, Δy, Δz) and the previous and current decoding positions (i.e., the x, y, and z coordinates of the previous and current image blocks, respectively). If the magnitude of any of the coordinate differences (i.e., the differences between the image values for the previous and current decoding positions) is larger than the displacement range (Δx, Δy, Δz), then the image block is decoded by the Decoder Module 215 and “replenished” with decompressed data. Otherwise, the image block is maintained as is, thereby reducing decoding time and computational complexity without at the expense of visual quality. For example, shaded blocks 225 and 230 in decoded image 220 are blocks that were replenished with decoded data. The other blocks in the decoded image 220 remain compressed, as decoding them would not alter the visual quality of the decoded image 220.

It is appreciated that the range of displacement (Δx, Δy, Δz) may vary from block to block and be dependent on several factors, such as, for example, the content of the scene being imaged, the time elapsed since a last block replenishment, or the speed of a viewer's eyes as tracked by a camera system connected to the display (e.g., camera system 140 in display portion 115 as shown in FIG. 1).

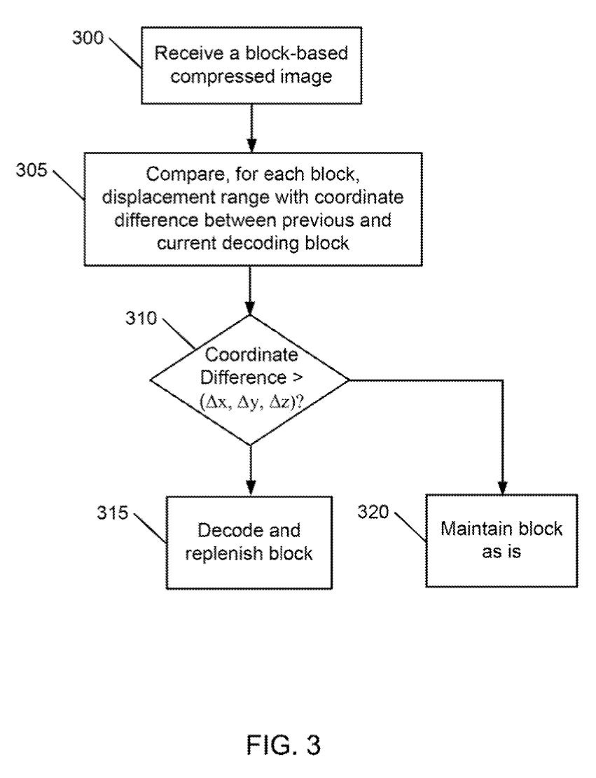

Referring now to FIG. 3, a flowchart for decoding a compressed 3D image in accordance with various embodiments is described. First, a compressed 3D image is received by the decoding architecture (300). The compressed 3D image is divided into blocks and stores in each block a displacement range (Δx, Δy, Δz) and compressed multi-dimensional and multi-view image data, such as projexel values for (x, y, z) coordinates for a 3D view of a natural scene. Next, the displacement range in each block is compared in the Spatial Thresholding Module 210 to the coordinate difference between a current decoding position and a previous decoding position. i.e., the differences between the image values for the previous and current decoding positions (305). If the difference is larger than the displacement range (Δx, Δy, Δz) (310), then the image block is decoded by the Decoder Module 215 and “replenished” with decompressed data (315). Otherwise, the image block is maintained as is, thereby reducing decoding time and computational complexity without at the expense of visual quality (320).

It is appreciated that the embodiments described herein may be implemented with a variety of compression schemes, such as MPEG, H.26*, or any other type of compression scheme for coding/decoding visual information. In some example implementations, one or more of the example steps of FIG. 3 may be implemented using machine readable instructions that, when executed, cause a device (e.g., a programmable controller or other programmable machine or integrated circuit) to perform the operations shown in FIG. 3. For instance, the example steps of FIG. 5 may be performed using a processor, a controller, and/or any other suitable processing device.

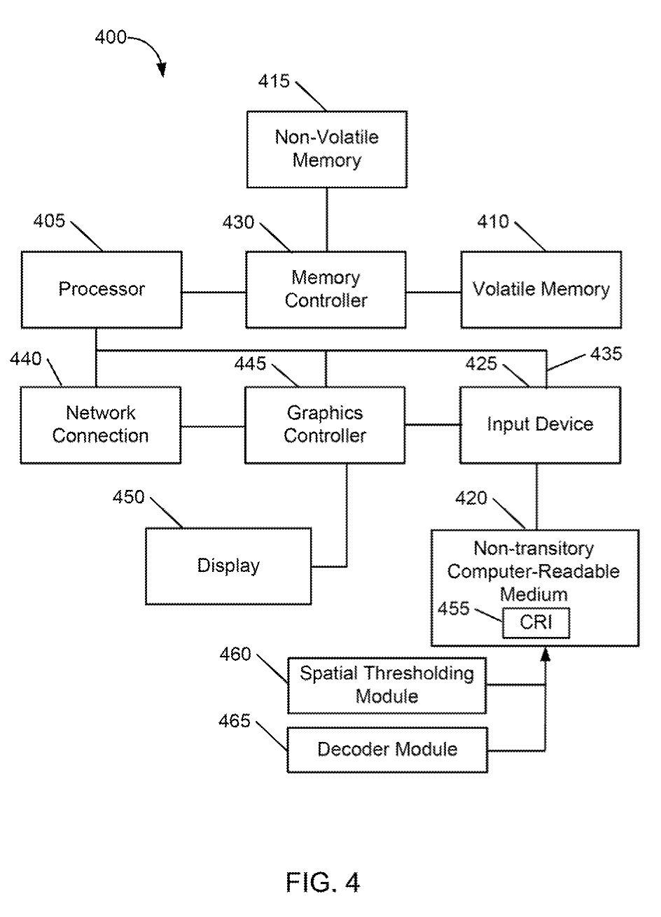

Referring now to FIG. 4, a block diagram of an example of a computing system 400 for decoding a compressed 3D image according to the present disclosure is described. The system 400 (e.g., a desktop computer, a laptop, or a mobile device) can include a processor 405 and memory resources, such as, for example, the volatile memory 410 and/or the non-volatile memory 415, for executing instructions stored in a tangible non-transitory medium (e.g., volatile memory 410, non-volatile memory 415, and/or computer readable medium 420) and/or an application specific integrated circuit (“ASIC”) including logic configured to perform various examples of the present disclosure.

A machine (e.g., a computing device) can include and/or receive a tangible non-transitory computer-readable medium 420 storing a set of computer-readable instructions (e.g., software) via an input device 425. As used herein, the processor 405 can include one or a plurality of processors such as in a parallel processing system. The memory can include memory addressable by the processor 405 for execution of computer readable instructions. The computer readable medium 420 can include volatile and/or non-volatile memory such as a random access memory (“RAM”), magnetic memory such as a hard disk, floppy disk, and/or tape memory, a solid state drive (“SSD”), flash memory, phase change memory, and so on. In some embodiments, the non-volatile memory 415 can be a local or remote database including a plurality of physical non-volatile memory devices.

The processor 405 can control the overall operation of the system 400. The processor 405 can be connected to a memory controller 430, which can read and/or write data from and/or to volatile memory 410 (e.g., RAM). The memory controller 430 can include an ASIC and/or a processor with its own memory resources (e.g., volatile and/or non-volatile memory). The volatile memory 410 can include one or a plurality of memory modules (e.g., chips).

The processor 405 can be connected to a bus 435 to provide communication between the processor 405, the network connection 440, and other portions of the system 400. The non-volatile memory 415 can provide persistent data storage for the system 400. Further, the graphics controller 445 can connect to a display 450 to provide a 3D image to a viewer based on activities performed by the system 400.

Each system 400 can include a computing device including control circuitry such as a processor, a state machine, ASIC, controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g., the non-transitory computer-readable medium 420). The non-transitory computer-readable medium 420 can be integral, or communicatively coupled, to a computing device, in either a wired or wireless manner. For example, the non-transitory computer-readable medium 420 can be an internal memory, a portable memory, a portable disk, or a memory located internal to another computing resource (e.g., enabling the computer-readable instructions to be downloaded over the Internet).

The non-transitory computer-readable medium 420 can have computer-readable instructions 455 stored thereon that are executed by the control circuitry (e.g., processor) to decode a compressed 3D image according to the present disclosure. For example, the non-transitory computer medium 420 can have computer-readable instructions 455 for implementing a Spatial Thresholding Module 460 and a Decoder Module 465. The Spatial Thresholding Module 455 keeps track, for each image block, of the displacement range (Δx, Δy, Δz) and the previous and current decoding positions (i.e., the x, y, and z coordinates of the previous and current image blocks, respectively). If the magnitude of any of the coordinate differences (i.e., the differences between the image values for the previous and current decoding positions) is larger than the displacement range (Δx, Δy, Δz), then the image block is decoded by the Decoder Module 465 and “replenished” with decompressed data. Otherwise, the image block is maintained as is, thereby reducing decoding time and computational complexity without at the expense of visual quality.

The non-transitory computer-readable medium 420, as used herein, can include volatile and/or non-volatile memory. Volatile memory can include memory that depends upon power to store information, such as various types of dynamic random access memory (“DRAM”), among others. Non-volatile memory can include memory that does not depend upon power to store information. Examples of non-volatile memory can include solid state media such as flash memory, EEPROM, and phase change random access memory (“PCRAM”), among others. The non-transitory computer-readable medium 420 can include optical discs, digital video discs (“DVD”), Blu-Ray Discs, compact discs (“CD”), laser discs, and magnetic media such as tape drives, floppy discs, and hard drives, solid state media such as flash memory, EEPROM, PCRAM, as well as any other type of computer-readable media.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. For example, it is appreciated that the present disclosure is not limited to a particular computing system configuration, such as computing system 400.

Those of skill in the art would further appreciate that the various illustrative modules and steps described in connection with the embodiments disclosed herein may be implemented as electronic hardware, computer software, or combinations of both. For example, the example steps of FIG. 3 may be implemented using software modules, hardware modules or components, or a combination of software and hardware modules or components. Thus, in one embodiment, one or more of the example steps of FIG. 3 may comprise hardware modules or components. In another embodiment, one or more of the steps of FIG. 3 may comprise software code stored on a computer readable storage medium, which is executable by a processor.

To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is:

1. A decoding architecture for decoding a multi-dimensional image for display in a light field display, the multi-dimensional image compressed in a plurality of blocks, each block storing compressed light field data and a displacement range, the decoding architecture comprising:
a spatial thresholding module to compare the displacement range in each block of the image to a difference between a current decoding position and a previous decoding position; and
a decoder module to decode a block if the difference is larger than the displacement range.

2. The decoding architecture of claim 1, wherein the displacement range comprises a spatial threshold (Δx, Δy, Δz) for each block.

3. The decoding architecture of claim 1, wherein the displacement range is encoded together with each block.

4. The decoding architecture of claim 1, wherein the difference comprises a difference in projexel values for spatial (x, y, z) coordinates in each block.

5. The decoding architecture of claim 1, wherein the decoder module replenishes a block in the image with decoded data if the difference is larger than the displacement range.

6. The decoding architecture of claim 1, wherein the decoder module maintains a block in the image with compressed data if the difference is smaller than the displacement range.

7. The decoding architecture of claim 1, wherein the displacement range is based on a content of a scene being imaged.

8. The decoding architecture of claim 1, wherein the displacement range is based on a time elapsed since decoding a previous block.

9. The decoding architecture of claim 1, wherein the displacement range is based on a speed of a viewer's eyes as tracked by a camera system connected to the light field display.

10. A non transitory, computer-readable storage medium comprising executable instructions to:
receive a compressed multi-dimensional image, the compressed image divided into blocks and storing for each block a displacement range and compressed multi-dimensional image data;
compare the displacement range in each block to a difference between a current decoding position and a previous decoding position; and
decode the each block if the difference is larger than the displacement range.

11. The non-transitory, computer-readable storage medium of claim 10, wherein the displacement range comprises a spatial threshold (Δx, Δy, Δz) encoded together with each block.

12. The non-transitory, computer-readable storage medium of claim 10, wherein the difference comprises a difference in projexel values for spatial (x, y, z) coordinates in each block.

13. The non-transitory, computer-readable storage medium of claim 10, wherein an image block is replenished with decoded data if the difference is larger than the displacement range.

14. The non-transitory, computer-readable storage medium of claim 10, wherein a block in the image is maintained with compressed data if the difference is smaller than the displacement range.

15. The non-transitory, computer-readable storage medium of claim 10, wherein the displacement range is based on a content of a scene being imaged.

16. The non-transitory, computer-readable storage medium of claim 10, wherein the displacement range is based on a time elapsed since decoding a previous block.

17. The non-transitory, computer-readable storage medium of claim 10, wherein the displacement range is based on a speed of a viewer's eyes as tracked by a camera system connected to the light field display.

18. A light field display for displaying a light field in a light field display, the light field display comprising:
a camera system to track a position of a viewer's eyes; and
a display, comprising:
a spatial thresholding module to receive a multi-dimensional image compressed in a plurality of blocks and compare a displacement range in each block of the image to a difference between a current decoding position and a previous decoding position; and
a decoder module to decode a block according to a result of the comparison.

19. The light field display of claim 18, wherein the decoder module replenishes a block if the difference is larger than the displacement range and maintains a block with compressed data if the difference is smaller than the displacement range.

20. The light field display of claim 18, wherein the displacement range is based on a speed of a viewer's eyes as tracked by a camera system connected to the light field display.
